(19) United States
(12) Patent Application Publication
(10) Pub. No.: US 2024/0119492 A1
(43) Pub. Date: Apr. 11, 2024

(54) CONTINUOUS GRANULAR REVIEWS AND RATINGS

(71) Applicant: INTERNATIONAL BUSINESS MACHINES CORPORATION, Armonk, NY (US)

(72) Inventors: Pavan Kumar Penugonda, Anakapalle (IN); Saraswathi Sailaja Perumalla, Visakhapatnam (IN); Venkata Ratnam Alubelli, Visakhapatnam (IN); Avinash Reddy Devireddy, Hyderabad (IN)

(21) Appl. No.: 18/045,619

(22) Filed: Oct. 11, 2022

(51) Int. Cl. G06Q 30/0282

(52) U.S. Cl. CPC G06Q 30/0282

(57) ABSTRACT

Computer implemented method, systems, and computer program products include program code executing on a processor(s) that determines that a user has purchased a product. The program code classifies, with at least one trained algorithm, the product into a product type classification. The program code implements one or more trigger events; based on each trigger event occurring, the processor(s) generates and transmits an inquiry to the user. The program code determines that a trigger event has occurred. The program code generates the inquiry, obtains responsive feedback, and generates a product review.

### BACKGROUND

Products, including computing resources, are comprised of various components. When determining the longevity of a product as a whole, the components of the product play a role. Oftentimes a certain component part will negatively impact the longevity, quality, and/or operability of a product, over time.

### SUMMARY

Shortcomings of the prior art are overcome, and additional advantages are provided through the provision of a computer-implemented method of facilitating granular real-time data attainment and delivery. The computer-implemented method includes: determining, by the one or more processors, that a user has purchased a product; classifying, by the one or more processors, with at least one trained algorithm, the product into a product type classification; implementing, by the one or more processors, one or more trigger events, wherein based on each trigger event occurring, the one or more processors automatically generate and transmit an inquiry to the user, wherein at least one of the one or more trigger events is implemented based on the product type classification; determining, by the one or more processors, that a trigger event of the one or more trigger events has occurred; based on the determining, generating, by the one or more processors, the inquiry to the user to solicit feedback on the product; obtaining, by the one or more processors, the feedback responsive to the inquiry; and generating, by the one or more processors, a product review based on the feedback obtained responsive to the inquiry.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one example of a computing environment to perform, include and/or use one or more aspects of the present invention;

FIG. 1B depicts one example of processing engines executable by a processor set of FIG. 1A, in accordance with one or more aspects of the present invention;

FIG. 2 depicts one example of a workflow in which aspects of the present invention can be integrated;

FIG. 3 depicts one example of a product utilized to illustrate the granularity of reviews generated by examples disclosed herein;

FIG. 4 depicts a workflow that illustrates various aspects of some embodiments of the present invention; and

FIG. 5 depicts one example of a machine learning training system used in accordance with one or more aspects of the present invention.

### DETAILED DESCRIPTION

When making purchasing decisions, consumers are guided by product information, including but not limited to, product reviews. Unfortunately, much of the information available about products is limited because it does not take into account a product as a whole, meaning that most products are assembled from constituent parts and the qualities of these parts can impact the product as a whole. Information about the components may not be readily available and thus, a consumer is unable to weigh issues related to components as well as the assembled produce, when making purchasing decisions. Components and/or materials that comprise a given product can include, but are not limited to, chemical ingredients, textiles, adhesives, etc. The terms product and object are used interchangeably herein and represent any good in commerce.

Embodiments of the present invention include computer-implemented methods, computer program products, and computer systems that include program code executing on one or more processors where the program code provides feedback to users on a granular level. In embodiments of the present invention, the program code provides feedback to consumers that is granular in nature at least because it utilizes data about the components (e.g., ingredients, materials) of a given product in determining data to provide to the customer. Thus, the program code can provide a rating which will improve customer experience. Various technical aspects in a computing environment work together in certain examples herein to enable accurate, timely, and granular product reviews. For example, to provide both timely and granular feedback, embodiments of the present invention can utilize an artificial intelligence (AI) and Internet of Things (IoT) integrated computing environment. Program code can utilize data from IoT devices, with weighting and gathering tuned using AI, to generate insights regarding product quality, durability, lifespan, and provide ratings to consumers premised on these qualities. The program code can generate, provide, and update these ratings while the product is in use. The ratings provided by the program code in embodiments of the present invention are more granular and specific than existing product rating systems both because of the temporal qualities on the rating system and because the program code, via the AI and IoT systems, monitors components of the product, external factors that could affect the product, such as supply chains, and the product, as a whole, when the program code produces these granular ratings. The program code can solicit customized user (purchaser) feedback during various points of the lifecycle of a product. For example, the program code can generate a customized survey to gather information of user experience about detailed artifacts of the product by considering individual parts and/or supply chains involved in overall process from manufacturing to delivery. Depending on the product, the program code can send the survey at pre-configured intervals. For examples, after an initial survey, the program code can trigger transmission of a follow-up survey based on the program code determining that the user is engaging in selected and/or buying a similar product. The program code can also communicate with IoT enabled home automation system, to solicit details regarding rarely used products after the purchase (in these cases, the user would provide the program code with access to these systems). The program code can utilize natural language processing (NLP) to parse existing generic feedback, including comments captured when services and/or repairs are performed, and convert this generic feedback into granular feedback for use in the ratings the program code produces. The program code can parse and filter the ratings and provide a portion of these data that is most relevant to user, for example, based on user demographics.

Embodiments of the present invention are inextricably tied to computing and are directed to a practical application. As will be described herein, aspects of embodiments of the present invention provide consumers with timely and granular product reviews that are enabled by utilizing elements of a technical infrastructure to determine the quality, viability, usability, etc., of the product during the life cycle of the product. The reviews provided by the program code are inextricably linked to computing at least because the technical infrastructure enables gathering, analysis, processing, and presentation of data comprising the reviews. Embodiments of the present invention utilize both AI and IoT devices to monitor and discover data related to products and to generate granular reviews based on the ability of at least these elements of the technical infrastructure to interact with these elements. For example, the AI systems through unsupervised learning can determine how to collect data about a given product or product type, based on ingesting feedback obtained from historical product reviews and/or based on being trained utilizing data classifying products in various categories. Based on these AI determinations, the program code can implement a schedule for a given product or product type and can collect data (classified by the AI as important in reviewing the product) at intervals the AI determines are valuable in the life of the product and its constituent parts. The program code can utilize IoT devices (with the permission of users) both to monitor product use and to discover additional products and request feedback about these products. Additionally, the program code can supplement knowledge from the IoT data and the surveys utilizing NLP to ingest unstructured data, such as comments on product review websites and, with the permission and knowledge of users, audio commentary about the product delivered proximate to one or more IoT devices.

Embodiments of the present invention provide significantly more than existing product review systems. As discussed herein, the reviews provided by program code in embodiments of the present invention are both granular and timely. Not only does the program code obtain data at (logical) intervals and/or continuously the program code also provides consumers with reviews at relevant times. For example, a novel use of technology enables these granular and timely reviews, including the use of AI and IoT devices to obtain continuous feedback based on schedules determined by the program code based, in part, on a defined and predicted lifecycle (as predicted by program code utilizing the AI functionality described here) of the product. The program code provides insights for product quality, durability, lifetime, and a consumer rating based on continuous feedback received while the product is in use. The program code provides these review (e.g., feedback) to consumer at relevant times, including but not limited to when the user takes actions related to replacing, fixing, upgrading, etc., the product and/or a similar product. The program code also collects feedback at relevant times. For example, the program code can trigger transmission of a survey to a customer when the program code determined that a consumer is choosing/buying another similar product within weeks or months (or based on threshold configuration based on item type) of the purchase of an item. Certain products have integrated IoT devices and the program code can monitor usage of the devices and survey a customer for feedback when usage of a given product is outside of a baseline. For example, if a user purchases a refrigerator and uses it daily but stops using it for a week, the program code can survey the user for the reason for the change in usage.

The program code also provides significantly more than existing consumer rating systems because the program code in examples herein generates a customized survey to gather information regarding a user experience that includes data regarding artifacts of the product. The survey generated by the program code queries data about individual parts (components) of a product as well as the supply chain, and all processes involved in providing a consumer with the product, from manufacturing to delivery. Thus, the insight provided by the program code in reviews is granular rather than only accounting for the product as a whole.

If a user is not forthcoming in providing feedback, the program code (with the permission of the user) can utilize IoT devices to parse commentary (audio and written) provided by the user that could be relevant to a product and supplement of complement feedback with this parsed (e.g., with a cognitive agent using natural language processing) commentary. The program code in embodiments of the present invention also provides significantly more than existing approaches to consumer reviews because the program code can utilize existing consumer reviews in addition to this commentary to enhance data from the granular review generated by the program code. Specifically, the program code can utilize NLP to analyze product comments from structured and/or unstructured data sources and update data the program code utilizes to generate reviews with these data. The program code can utilize these additional data to complement and/or supplement reviews generated by the program code.

The program code also provides a significant advantage over existing approaches because the program code can obtain demographic information about consumers, determine when the demographic information is relevant to the reviews, and provide the user with reviews that are relevant (e.g., an individual who lives in a cool climate would not be provided with a review that is relevant to product performance only in a warm climate). In another example, the program code can generate a review for a given product that discards feedback received from users who are not demographically relevant to the user obtaining the review. For example, feedback related to a bicycle that is critical of a feature that has a higher failure rate when a user is above a certain weight may not be relevant to a user who is petite. Thus, the program code can filter the feedback when generating a granular review and/or filter a previously generated review to product a review that is more relevant to the user, based on demographic information related to the user (which the program code can obtain via one or more IoT devices proximate to the user).

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

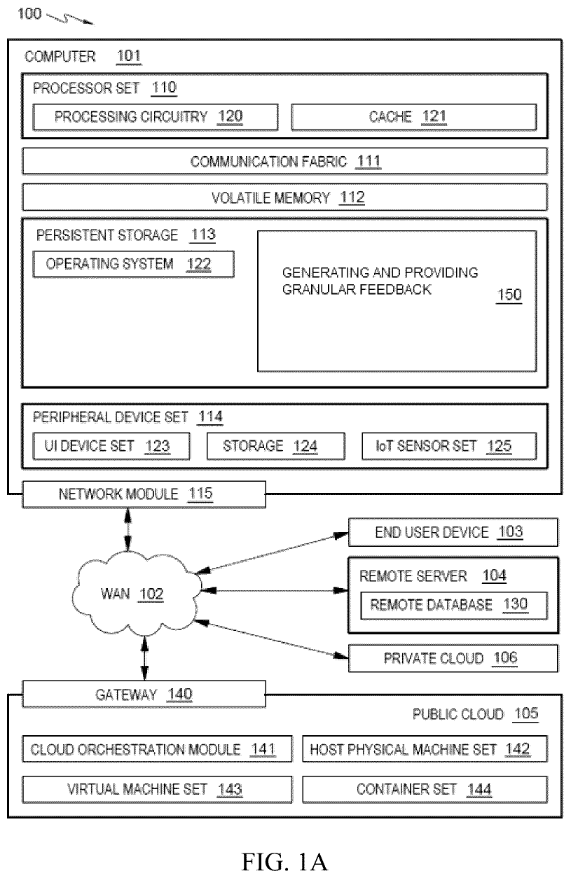

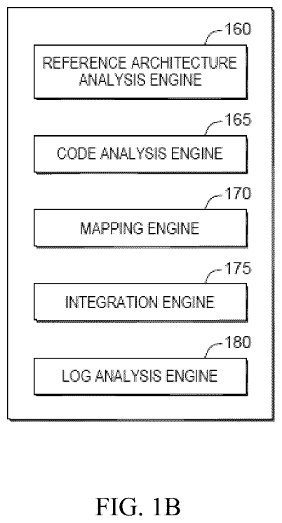

One example of a computing environment to perform, incorporate and/or use one or more aspects of the present invention is described with reference to FIG. 1A. In one example, a computing environment 100 contains an example of an environment for the execution of at least some of the computer code involved in performing the inventive methods, such as a code block for generating and providing granular feedback to users 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. As described herein, an IoT sensor 125 can be utilized to collect audio which can be parsed by a cognitive agent.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104. As discussed herein, historical data can be utilized as training data to train a classifier.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In one or more aspects, to automatically navigate between a reference architecture and a code repository, various processing engines executed by one or more computers, such as computer(s) 101, are used. For instance, the processing engines are executed by one or more processors of one or more processor sets (e.g., processor set(s) 110) and/or using processing circuitry (e.g., processing circuitry 120) of the one or more processor sets. Example processing engines used to perform one or more aspects of the present invention are described with reference to FIG. 1B, and include, for instance: a reference architecture analysis engine 160 to perform analysis of the reference architecture; a code analysis engine 165 to perform analysis of code of the code repository; a mapping engine 170 to map code components of the code repository with components of the reference architecture; an integration engine 175 to correlate the reference architecture and the code repository; and a log analysis engine 180 to perform analysis of logs generated by applications of the code repository. Although example engines are provided, additional, fewer and/or other processing engines may be used.

As noted above, in some embodiments of the present invention, program code executing on one or more processors utilizes an artificial intelligence (AI) and IoT integrated ecosystem to gather continuous and granular feedback about purchased products and/or objects such that product information can include data related to the product while it is in use, over time.

As understood by one of skill in the art, the Internet of Things (IoT) is a system of interrelated computing devices, mechanical and digital machines, objects, animals and/or people that are provided with unique identifiers and the ability to transfer data over a network, without requiring human-to-human or human-to-computer interaction. These communications are enabled by smart sensors, which include, but are not limited to, both active and passive radio-frequency identification (RFID) tags, which utilize electromagnetic fields to identify automatically and to track tags attached to objects and/or associated with objects and people. Smart sensors, such as RFID tags, can track environmental factors related to an object or an area, including but not limited to, temperature and humidity. The smart sensors can be utilized to measure temperature, humidity, vibrations, motion, light, pressure and/or altitude, which in these examples can help inform product durability in different environmental conditions. IoT devices also include individual activity and fitness trackers, which include (wearable) devices or applications that include smart sensors for monitoring and tracking fitness-related metrics such as distance walked or run, calorie consumption, and in some cases heartbeat and quality of sleep and include smartwatches that are synced to a computer or smartphone for long-term data tracking. Because the smart sensors in IoT devices carry unique identifiers, a computing system that communicates with a given sensor can identify the source of the information. Although in some embodiments of the present invention, users actively register IoT devices for utilization by the program code, in some embodiments of the present invention, the program code could automatically discover possible IoT devices and request confirmation from the user. Within the IoT, various devices can communicate with each other and can access data from sources available over various communication networks, including the Internet. Certain IoT devices can also be placed at various locations and can provide data based in monitoring environmental factors at the locations.

In embodiments of the present invention, the program code utilizes one or more IoT devices to monitor product durability and performance over time. Because IoT devices are prevalent given that they can be carried by users, worn by users, and situated in physical environments utilized by users, the program code can continuously collect data from these devices, as these devices monitor a given product. The data from the IoT devices can also provide granular insight into the components of each product, detailing which components are experiencing longevity issues. IoT devices can monitor and capture product-related activity through the collection of a wide range of data. IoT devices can collect video, image, movement, and audio data, all of which can assist the program code in determining the durability of a product and the components of the product over time.

As discussed herein, utilization of various IoT devices in monitoring product qualities, including durability, over time, can be triggered through the integration of artificial intelligence (AI) into various embodiments of the present invention. Program code in embodiments of the present invention can utilize the data collected by the IoT devices as parameters and the program code can enter these parameters into artificial intelligence (AI) systems, for model training and machine learning. One such system, provided by way of example, only, and not to imply any limitations, is IBM Watson®, which the program code in some embodiments of the present invention can utilize as a cognitive agent (e.g., AI) to perform one or more of the described analyses. IBM Watson® is a registered trademark of International Business Machines Corporation, Armonk, New York, US. By analyzing data collected based on continuously monitoring a product, including the performance of the (purchased) product, the AI can generate a composite recommendation or review related to the product. The AI can also adjust monitoring of the product or type of product moving forward based on determining the quality of the data provided and the frequency at which the data provides insights into the product. In some examples, the program code can recommend a schedule for soliciting feedback on a type of product based on monitoring products of this type over time.

Embodiments of the present invention also utilize natural language processing (NLP). Existing cognitive agents can be utilized for NLP, including but not limited to those which are included in IBM Watson®. For example, three APIs that can be utilized in embodiments of the present invention for NLP include, but are not limited to, IBM Watson® Natural Language Classifier (NLC), IBM Watson® Natural Language Understanding, and IBM Watson® Tone Analyzer. As understood by one of skill in the art, the IBM Watson® APIs are only provided to offer an example of possible APIs that can be integrated into embodiments of the present invention and to illustrate the functionality of the program code in embodiments of the present invention, whether through integration of an existing cognitive engine or not.

In some embodiments of the present invention, the cognitive natural language processing (NLP) capabilities of the program code are implemented as a machine learning system that includes a neural network (NN). In certain embodiments of the present invention the program code utilizes supervised, semi-supervised, or unsupervised deep learning through a single- or multi-layer NN to correlate various attributes from unstructured and structured data related to a product (e.g., gathered by the program code from IoT devices). The program code utilizes resources of the NN to identify and weight connections from the attribute sets in the product data gathered. For example, the NN can identify certain keywords that are relevant to a product. As will be discussed herein, the program code can also utilize an NN when classifying products into categories (e.g., product types).

As understood by one of skill in the art, neural networks are a biologically inspired programming paradigm which enable a computer to learn from observational data. This learning is referred to as deep learning, which is a set of techniques for learning in neural networks. Neural networks, including modular neural networks, are capable of pattern recognition with speed, accuracy, and efficiency, in situation where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing (NLP). Thus, by utilizing an NN the program code can identify attributes and classify these attributes as relevant to various products or types of products.

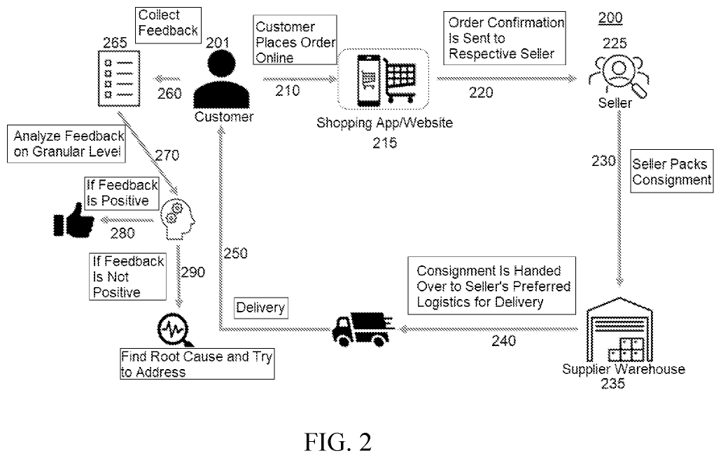

Embodiments of the present invention include methods, computer program products, and systems which obtain granular product feedback and generate and provide granular product reviews to customers and perspective customers. The timing utilized by the program code in soliciting, generating and providing these reviews and the data underlying these reviews is enabled by a technical infrastructure that includes IoT devices and AI. FIG. 2 is an example of a workflow 200 that includes illustrations of various aspects of some embodiments of the present invention. As will be explained, portions of the workflow 200 are completed by different systems (e.g., an ecommerce website and a fulfillment system). The workflow 200 serves to illustrate to integration of aspects of the present invention into a workflow 200 that includes product purchase through usage.

In the workflow 200, a customer 201 places an order for a product (210). The program code obtains this order. As illustrated in the workflow 200, the user purchases the product using a transaction that is electronic, in this example, a shopping application or an ecommerce website 215. Embodiments of the present invention can also be implemented in environments where the customer makes an in-person purchase by the program code obtains data related to this purchase subsequent to this purchase, for example, based on obtaining a notification and/or based on communicating with a purchase database of a third-party system, etc. In FIG. 2, the program code will obtain a notification or other data that a product has been purchased through electronic means, but the product itself could have been purchased in-person or via ecommerce.

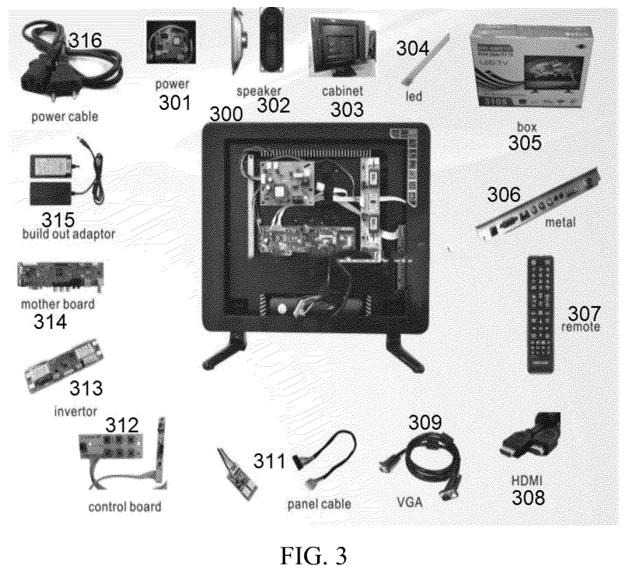

The commerce system 215 send a confirmation of the order (in this example) to a seller 225 (220). The seller (or a fulfilment party selected by the seller) fulfills the order (230), in this example, from a warehouse 235 and the product is consigned to a handling company (240) and delivered (250) to the customer 201. In some embodiments of the present invention, upon delivery of the product, the program code generates a survey 265 and transmits the survey 265 to the user 201 (260). The survey can be transmitted and obtained by the user using a variety of media options, including email, text, audio, etc. The program code obtains the feedback from the survey 265 and analyzes the data provided granularly (270). Thus, the program code aggregates data regarding components comprising the product as well as the product as a whole. FIG. 3 illustrates a product 300 and its components parts. The data obtained by the program code is granular in that it accounts for parameters (performance, durability, longevity, etc.) of individual components such that the reviews generated and provided by the program code can also provide this granular data.

FIG. 3 is an example of a product 300 with component parts illustrated. FIG. 3 is provided to illustrate how in embodiments of the present invention the program code obtains feedback and generates reviews based on component parts of products—FIG. 3 shows an object and its component parts, feedback upon all of which the program code can integrate into a review. Program code in embodiments of the present invention collects and provides data in its reviews that account for performance, durability, longevity, etc., of individual components comprising the product 300, in this case, a television. For example, the feedback or review provided by the program code may indicate to a consumer that various component parts of the product have different expected lifespans. A review generated by the program code, based on feedback received from IoT devices (as explained herein) could indicate that the remote 307, is predicted to fail after three years, while the additional components have a longer predicted lifespan. The consumer can therefore make a purchasing decision based on this consumer's concern regarding the feasibility of replacing a remote if the consumer's intended time of use for the television exceeds this predicted time period. As illustrated in FIG. 3, the television, the product 300, is comprised of a power brick (supply) 301, a speaker 302, a cabinet 303, a light emitting diode (LED) array 304, a box 305 (which may not be a component that impacts a purchasing decision, metal 306 (components can be self-contained electrical components as well as materials that comprise an object), a remote 307, HDMI 308, VGA 309, and panel cables 311, a control board 312, an inverter 313, a mother board 314, a build-out adapter 315, and a power cable 316.

Returning to FIG. 2, in some embodiments of the present invention, the granularity of the reviews generated and provided by the program code can trigger various actions related to the product. The program code analyzes the feedback on a granular level (270). As will be explained herein, the feedback can be both feedback provided by a user in response to a survey (where the survey is triggered by various pre-configured events in the lifecycle of product ownership by the consumer), and feedback obtained passively by IoT devices integrated into and in proximity to the product, which is analyzed by the program code with a cognitive agent and used to complement and/or supplement the feedback actively provided by the consumer. In this example, if the product review generated and provided by the program code is positive, the program code can take no further action (280). However, if the feedback is negative, the program code can analyze the feedback to determine a root cause of the issue (290), for example a specific part failing and/or showing wear. The program code can generate a review with this information about this specific part. Additionally, the program code could provide this feedback to the vendor such that the vendor could address this issue with this specific part.

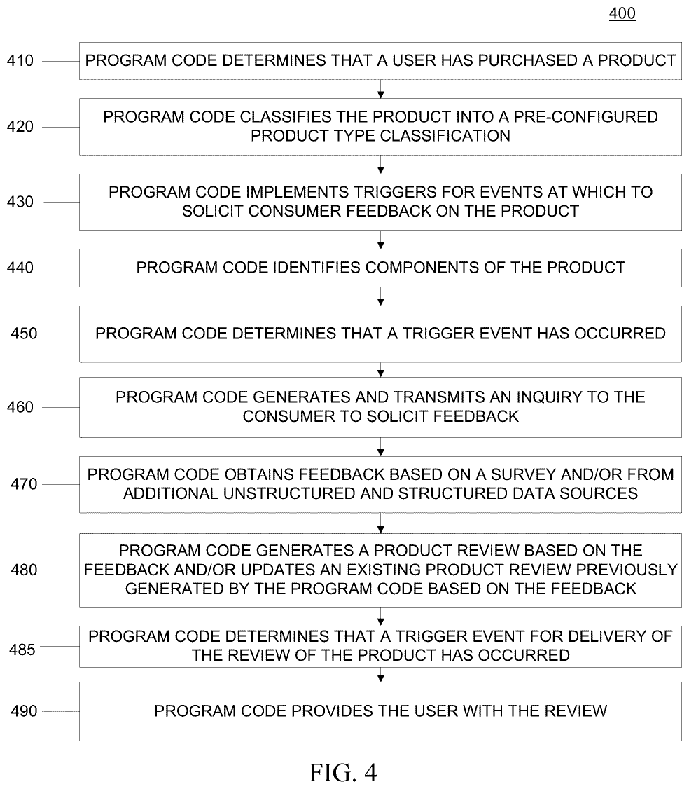

FIG. 4 is a workflow 400 that focusses on aspects of some examples rather than integrating these aspects into a purchasing process which includes additional systems, as illustrated in FIG. 2. As illustrated in FIG. 4 and discussed earlier, an advantage of the examples herein is that the program code in these examples can both collect data at times in a lifecycle of product ownership where a consumer of the product (and/or other individuals who interact with the product) can provide useful information about the product and the program code can provide the reviews it generates from the feedback it collects at times in which these reviews are beneficial to the consumer. Both the collection of data (by the program code) and providing the reviews (generated by the program code) can be triggered by pre-configured events. For example, the program code can be configured to solicit feedback from a consumer upon acquisition of the product by the consumer, when the consumer seeks to repair the product, when the pre-established usage patterns of the product by the consumer and/or by a relevant population, deviate from expected usage, when the consumer takes actions online that indicate the consumer is replacing the product and/or purchasing a similar product, etc. The program code can be configured to provide a review to a consumer, for example, when the pre-established usage patterns of the product by the consumer and/or by a relevant population, deviate from expected usage, when the consumer takes actions online that indicate the consumer is replacing the product and/or purchasing a similar product, when the user is at a point of purchase to purchase the product (e.g., when the user has placed the product in an electronic shopping cart on an e-commerce application and/or website), etc. As understood by consumers, receiving solicitations for product information and/or product reviews at unexpected and/or irrelevant times diminishes the likelihood that the consumer will interact with the solicitation and/or review. By timing the solicitations and review delivery, the program code increases a likelihood of obtaining and delivering quality data that is utilized by the consumer.

In FIG. 4, the program code determines that a user has purchased a product (410). The program code can obtain this information from a variety of sources, including but not limited to from monitoring a personal device of a user (with the permission of the user) which the user utilizes to purchase the product. The program code can also obtain these data from a vendor of the product. In some examples, the user may have enabled the program code to monitor IoT devices proximate to the user, including smart home devices, surveillance devices, the user's phone, etc. In this example based on the (permitted and agreed to) monitoring, the program code can determine that a user has purchased the product. As the purchase and eventual replacement of a product can be viewed as cyclical, the program code could have provided the consumer with a review at the point of purchase that influenced the user's purchase of the product.

The program code classifies the product into a pre-configured product type classification (420). Based on the classification, the program code implements triggers for events at which to solicit consumer feedback on the product (430). To classify a given product, the program code can utilize an AI classifier that has been trained utilizing input data of various product and product types, including but not limited to, historical order data. The classifier can solicit feedback based on the classifications that it makes and can retrain and improve its classification algorithms (e.g., utilizing unsupervised machine learning) so that the classifications continue to improve in accuracy. In some examples, a user has provided trigger events based on the pre-defined types into which the program code classifies the products. In some examples, the program code maintains a database of product types and triggers for each product types which the user can update (e.g., through a graphical user interface generated by the program code).

In some examples, the program code identifies components of the product (440). To determine components (or ingredients, raw materials, etc.) for a given product, the program code can parse private and/or public information available to the program code. For example, the program code can search for and locate a manual for a given product. Returning to FIG. 3, a manual for the product 300 could include a list of component parts. In some examples, the program code can search available repair records for the product (using a network of IoT devices) and update the component list with only the components with a threshold number of repairs within a defined window of time post-acquisition of the product. For example, the program code could determine, based on a manual, that a product includes 200 component parts but that only 10 of these parts fail within three years of product ownership and/or are an impetus for a visit to a repair shop (and/or are the subject of complaints on a public online forum) more than 30% of the time that the product is brought for a repair. Thus, the program code could solicit feedback and generate reviews with data pertaining to these 10 parts (e.g., as well as the product as a whole and/or instead of the product as a whole).

The program code determines that a trigger event has occurred (450). The program code generates and transmits an inquiry to the consumer to solicit feedback (460). As aforementioned, the triggers can be pre-configured events within the lifecycle of a product. Certain trigger events can be tied to product type while others can be more general, such as a trigger event for all products can be when a product is taken to a repair shop and/or when a consumer of a product is searching a web store for a similar product (e.g., a product of the same type). In some embodiments of the present invention, the trigger event can be delivery of the product to the user (data provided to the program code by IoT devices proximate to the user or integrated into the product itself).

As discussed above, the program code utilizes IoT devices to monitor product usage and thus, the trigger event can be that the program code determines that the usage of the product is outside of a baseline established either by monitoring the user or a baseline the program code established by monitoring a population utilizing the same product and/or products of a same type. For example, if the product is a refrigerator and based on monitoring usage (either through an integrated IoT device or a device proximate to the refrigerator) the program code determines that the user utilizes the refrigerator daily. For a week, while present at the location of the refrigerator (as indicated by IoT devices utilized by the user, including a personal device such as a smartphone) rather than utilize the refrigerator daily, the user only utilizes the refrigerator once. This change in usage can be a pre-configured trigger event. The program code can generate and transmit a survey to the user to inquire as to why the usage of the refrigerator has changed. Responsive to the survey, the user could provide information that a latch of the door of the refrigerator is not working properly and making access to the refrigerator challenging. This type of feedback is granular and the program code can integrate this feedback into the product review, which will include information about the expected lifespan of various components of the product. Alternatively, and/or additionally, if the user does not provide this feedback, the program code (with the permission and knowledge of the user) can obtain this data passively based on monitoring communications of the user proximate to IoT devices monitoring the refrigerator.

The program code tying certain triggering events to a product type assists the program code in soliciting feedback at times that result in obtaining relevant feedback that increases the quality level of the reviews generated by the program code. The program code generates and transmits surveys at various stages after the actual purchase to get real feedback, but these various stages can vary based on the product or product type. For example, if a user purchases a wallet and provides feedback soon after purchase, that feedback may not be relevant or helpful in determining the longevity of the product because the user experience is likely positive for this product, as far as wear and tear, for few weeks. The longevity of this type of product is likely tested more completely through a more extended use and thus, the program code can solicit feedback for this type of product after a longer interval has passed.

Various events can trigger the program code to generate and transmit a survey or other solicitation for feedback from a product user/consumer. For example, the program code can send an inquiry to a consumer when the program code determines that the user is selecting and/or purchasing a product similar to the purchased product within a given threshold. For example, a user may have purchased a product with a shelf-life of four weeks but is purchasing a competing product after only three days. Additionally, if a user changes to a new brand of a product that user generally purchases, even if the new purchase is at an expected interval for this user (and/or a similar population or the population at large) and that type of product, the purchase of the competing product instead of the product from a brad to which the purchaser was previously loyal, can be a trigger event. In a non-limiting example, the program code determines that the user has purchased a first brand of night cream but purchased a second brand of night cream within a few days (e.g., before an average person could have used the first night cream and/or before this particular purchaser generally would purchase a new night cream). The program code can generate a survey to solicit feedback regarding the reasoning behind this purchase, which deviated from an expected behavior. The survey can request feedback regarding whether: the user wanted to try the second brand, the user's satisfaction with the first brand, what motivated the user to purchase the second brand (e.g., a recommendation from a friend), whether the purchase of the second brand was for personal use or as a gift for another person.

In addition to a deviation from expected or established use of a product being a possible trigger, non-use of a consumer product could also be a trigger event for the program code generating and transmitting a survey. For example, the program code can trigger a survey for delivery by an IoT device that is integrated into a home automation system (with the permission of the user). This device can provide usage information to the program code and the program code can determine that a purchased product is not being used by the purchaser or has not been used by the purchaser within a pre-configured threshold and can generate and deliver a survey. For example, a user can purchase an oven, use the oven a single time, and then not use it again for a month. Based on obtaining this event (this lack of use over this period of time), the program code can generate and send a survey to the user to determine why the user is not using the oven. The survey can solicit information about possible factors including, but not limited to, whether: the manual is unclear, cleaning the oven presents a challenge, power consumption is greater than expected, the controls are difficult to use, etc.

The program code obtains feedback based on a survey and/or from additional unstructured and structured data sources (470). The program code can obtain a survey response as one form of feedback. Additionally, the program code can complement and/or supplement this feedback with unsolicited feedback. Continuing with the example of the less frequently used refrigerator, the program code can utilize a cognitive agent to parse audio from a physical area proximate to the refrigerator for specific feedback that includes reasoning for why the user is not utilizing the refrigerator. For example, the user may have complained about the latch. Additionally, the program code can search for unsolicited information provided by the user about the product, for example, on a comments page, that may provide the reasoning for the user's change in usage of the refrigerator. As aforementioned, the program code can apply NLP to parse this unsolicited feedback. Based on the product, the program code can obtain additional feedback from additional sources, including parsing general product reviews on ecommerce websites.

The survey that the program code transmits to the user can be customized by the program code based on the event that triggered the survey. For example, a change in usage could trigger a survey that requests a reason for the change in usage. Meanwhile, if the program code determines that the user is seeking repair services, the program code can solicit information from both the customer and the repair facility regarding the details of the perceived issue and/or the resolution of this issue. Meanwhile, a survey generated and transmitted to the program code upon receipt of the product could inquire about the packaging and safety of the product in transport. The program code can also customize a survey based on user demographics. For example, the program code may not include a question about product performance in cold temperatures to a user in a year-round warm climate.

The program code generates a product review based on the feedback and/or updates an existing product review previously generated by the program code based on the feedback (480). The feedback includes both the feedback solicited via the custom surveys as well as additional unsolicited feedback obtained and analyzed by the program code (e.g., utilizing NLP). The program code can utilize the unsolicited feedback to fill gaps as the feedback provided by the users responsive to the custom surveys can be more timely and more granular. Thus, the program code can utilize the data obtained based on applying NLP to unstructured data (audio, text comments, etc.), to update the data provided by the consumers and thus, it can be complementary and/or supplementary. The program code can weight certain of the feedback more heavily in the review based on the relevance of the event that triggered the feedback solicitation. For example, the feedback provided at the initial purchase of the product regarding the brightness of the monitor may be weighted as less important by the program code than this same feature after the product has been in use for two years.

The program code determines that a trigger event for delivery of the review of the product has occurred (485). Just as there are trigger events for querying a user about a product, embodiments of the present invention can include configured events for delivery of a product review. These events can include, but are not limited to, the user bring a product to be serviced, the user querying an ecommerce site regarding similar products, a user initiating a purchase of a replacement product (e.g., placing a replacement product in a shopping cart on an ecommerce website).

Based on determining that the event has occurred, the program code provides the user with the review (490). A trigger event for delivery of a review can also be a trigger event for generating and transmitting a survey (or otherwise collecting feedback). In some examples, the program code, before providing the review, can filter the review based on demographic information about the user to eliminate irrelevant data (just as the program code can customize a survey based on demographic information). For example, if a user lives in a cold climate and some feedback about the product, as car, is that it overheats in over 100-degree heat, the program code can filter the review and as a result, the program code will not provide this information to the user as part of the review. Rather than eliminate information, the program code can configure the review to highlight certain information and/or place it in a more visually prominent location in the review, based upon demographic information related to the user. For example, the feedback on a product, a stroller, may include information that the handle is very accommodating for users who are under 5′2″ tall. Based on the demographic information related to the user (obtained by the program code in communication with a wearable device of the user, with the knowledge and consent of the user), the program code determines that the user is under 5′2″ and highlights this information (e.g., visually) when providing the review.

If a product is new to market, review data related to its usage may not be available. Thus, the program code can therefore utilize data regarding the individual parts comprising the product and how they performed in other products to provide a review. Because the reviews are granular and the parts that comprise the product are part of the review, the program code can provide a quality review by utilizing data related to component performance in other products, or related to similar product (e.g., the last version of the product), in generating a review to provide to the consumer.

The program code can provide the user with the review utilizing a variety of different notification and visualization technologies. For example, while a user is engaged in an activity that triggered delivery of the review, the program code can send an alert (e.g., audio, visual, haptic, etc.) to a computing device the user is utilizing the engage in the activity to indicate that a review is available to view. The program code can also populate the review in a graphical use interface proximate to the user, including on the aforementioned device. If a user in participating in a transaction in person, the program code can populate the review on a transaction screen at the point-of-sale. In some examples, an individual user can configure how the user would prefer to receive reviews and/or alerts that review are available. In some examples, the user can provide feedback to indicate whether a review is relevant and/or helpful and the program code can update the review based on this feedback.

Embodiments of the present invention generate and provide ratings that are timely, relevant, and granular. The program code in embodiments of the present invention can solicit and otherwise gather product data at different events in the lifecycle of a product, including but not limited to, the gathering of raw materials to create the product, the completion of the product, delivery of the product, and various usage all events. The program code utilizes the feedback gathered various events to generate a product review. As explained herein, the program code can utilize publicly available product information as well as reviews of similar products or data related to the individual components (when integrated into different products) to supplement and/or complement the review the program code generates.

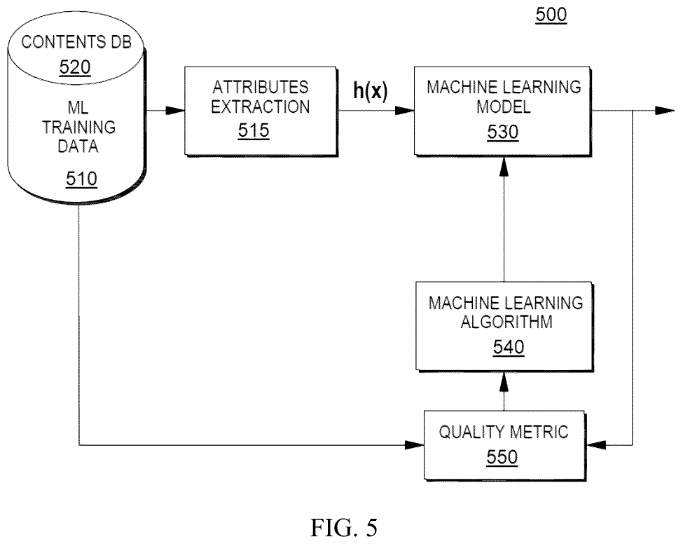

As noted herein, the program code can be trained to classify products into types such that certain triggering events can be associated with a given product. FIG. 5 is one example of a machine learning training system 500 that may be utilized, in one or more aspects, to perform cognitive analyses of various inputs, including product data which can include historical data. Training data utilized to train the model in one or more embodiments of the present invention includes, for instance, product databases from various suppliers, manufacturers, ecommerce engines, etc. The program code in embodiments of the present invention performs a cognitive analysis to generate one or more training data structures, including algorithms utilized by the program code to classify a type of a product. Machine learning (ML) solves problems that are not solved with numerical means alone. In this ML-based example, program code extracts various attributes from ML training data 510 (e.g., data collected from various data sources relevant to products and types), which may be resident in one or more databases 520. Attributes 515 are utilized to develop a predictor or classifier function, h(x), also referred to as a hypothesis, which the program code utilizes as a machine learning model 530.

In identifying various product types, features and/or parameters indicative of product types in the ML training data 510, the program code can utilize various techniques to identify attributes in an embodiment of the present invention. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model 530 (e.g., the algorithms utilized by the program code), including providing weights for the conclusions, so that the program code can train the predictor functions that comprise the machine learning model 530. The conclusions may be evaluated by a quality metric 550. By selecting a diverse set of ML training data 510, the program code trains the machine learning model 530 to identify and weight various attributes (e.g., features, patterns, components) that correlate to product types.

The model generated by the program code is self-learning as the program code updates the model based on active event feedback, as well as from the feedback received from data related to the event. For example, when the program code determines that there is information that was not previously predicted or classified by the model, the program code utilizes a learning agent to update the model to reflect the product type, to improve classifications in the future. Additionally, when the program code determines that a classification is incorrect, either based on receiving user feedback through an interface or based on monitoring related to the event, the program code updates the model to reflect the inaccuracy of the classification for the given period of time. Program code comprising a learning agent cognitively analyzes the data deviating from the modeled expectations and adjusts the model to increase the accuracy of the model, moving forward.

In one or more embodiments, program code, executing on a processor set, utilizes an existing cognitive analysis tool or agent (or one to be developed) to tune or update reviewed generated by the program code. One or more embodiments utilize, for instance, an IBM Watson® system as the cognitive agent. In one or more embodiments, the program code interfaces with IBM Watson Application Programming Interfaces (APIs) to perform a cognitive analysis of obtained data (e.g., audio from proximate to a product, publicly available product review, etc.). Specifically, in one or more embodiments, certain of the APIs of the IBM Watson API comprise a cognitive agent (e.g., learning agent) that includes one or more programs, including, but not limited to, natural language classifiers, Retrieve and Rank (i.e., a service available through the IBM Watson Developer Cloud™ that can surface the most relevant information from a collection of documents), concepts/visual insights, trade off analytics, document conversion, and/or relationship extraction. In an embodiment, one or more programs analyze the data obtained by the program code across various sources utilizing one or more of a natural language classifier, retrieve and rank APIs, and trade off analytics APIs. The IBM Watson Application Program Interface (API) can also provide audio related API services, which can be utilized by the program code, including but not limited to NLP, text to speech capabilities, and/or translation. IBM Watson Developer Cloud™ is a registered trademark of International Business Machines Corporation in at least one jurisdiction. The audio collection is relevant in embodiments of the present invention because the program code utilizes audio commentary provided both responsive to a survey as well as proximate to a product (with the permission of the user) to generate product reviews.

In one or more embodiments, the program code utilizes a neural network to analyze event-related data to generate the model utilized to predict or classify a product as a given product type. Because of the speed and efficiency of neural networks, especially when parsing multiple complex data sets, neural networks and deep learning provide solutions to many problems in multiple source processing, which the program code in one or more embodiments accomplishes when obtaining data and generating a model for classifying products purchased by consumers into type classifications to associate the products with triggering events.

One or more aspects, including, but not limited to, analysis, mapping and navigational aspects, may utilize AI, and in particular, machine learning in the decision-making process. A model is trained to be able to perform certain tasks, such as, but not limited to classify products as various product types to automatically configure various triggering events which are relevant to the product. Other aspects may also be performed by AI (e.g., machine learning).

Embodiments of the present invention include computer-implemented methods, computer systems, and computer program products where program code executing on one or more processors determine that a user has electronically purchased a product. The program code classifies, with at least one trained algorithm, the product into a product type classification. The program code implements one or more trigger events, where based on each trigger event occurring, the one or more processors automatically generate and transmit an inquiry to the user, where at least one of the one or more trigger events is implemented based on the product type classification. The program code determines that a trigger event of the one or more trigger events has occurred. Based on the determining, the program code generates the inquiry to the user to solicit feedback on the product. The program code obtains the feedback responsive to the inquiry. The program code generates a product review based on the feedback obtained responsive to the inquiry.

In some examples, the program code identifies, based on the product type classification, one or more components comprising the product, wherein the inquiry solicits granular information on at least a portion of the one or more components.

In some examples, the product review comprises the granular information.

In some examples, the program code obtains unstructured feedback relevant to the product. The program code analyzes the unstructured feedback via a natural language processing algorithm to isolate granular feedback pertaining to components comprising the product. The program code updates the product review based on the granular feedback.

In some examples, the program code obtaining the unstructured feedback comprises: the program code controlling at least one Internet of Things device to monitor an area proximate to the product, where the unstructured feedback comprises audio data collected by the at least one Internet of Things device.

In some examples, the program code obtaining the unstructured feedback comprises: the program code identifying on one or more public product review sites, text relevant to the product, where the unstructured feedback comprises the text.

In some examples, each event of the one or more trigger events is selected from the group consisting of: taking delivery of the product, purchasing a similar product, requesting a repair for the product, and utilizing the product in a manner outside an established pattern of use.

In some examples, the program code determining that a trigger event of the one or more trigger events has occurred comprises: the program code controlling at least one Internet of Things device to monitor an area proximate to the product. Based on the monitoring, the program code generates a baseline model representing a usage pattern of the product by the user. The program code identifies at least one outlier to the baseline model.

In some examples, the program code determining that a trigger event of the one or more trigger events has occurred comprises: the program code controlling at least one Internet of Things device to monitor an area proximate to the product. Based on the monitoring, the program code determines that the user has not utilized the product within a pre-configured time window for usage of the product.

In some examples, the program code generating the product review based on the feedback obtained responsive to the inquiry further comprises: the program code determining if there is an existing product review for the product. Based on the program code determining that there is an existing product review for the product, the program code updates the existing review to generate the product review. Based on the program code determining that there is no existing review, the program code generates the product review based on the feedback obtained responsive to the inquiry.

In some examples, the program code determines that a trigger event for delivery of the product review of the product has occurred. The program code transmits the product review to the user.

In some examples, the program code obtains from one or more Internet of Things devices proximate to the user, demographic information related to the user. The program code filters the product review based on the demographic information. The program code transmits the filtered review to the user.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating granular real-time data attainment and delivery, the method comprising:
determining, by one or more processors, that a user has electronically purchased a product;
classifying, by the one or more processors, with at least one trained algorithm, the product into a product type classification;
implementing, by the one or more processors, one or more trigger events, wherein based on each trigger event occurring, the one or more processors automatically generate and transmit an inquiry to the user, wherein at least one of the one or more trigger events is implemented based on the product type classification;
determining, by the one or more processors, that a trigger event of the one or more trigger events has occurred;
based on the determining, generating, by the one or more processors, the inquiry to the user to solicit feedback on the product;
obtaining, by the one or more processors, the feedback responsive to the inquiry; and
generating, by the one or more processors, a product review based on the feedback obtained responsive to the inquiry.

2. The computer-implemented method of claim 1, further comprising:
identifying, by the one or more processors, based on the product type classification, one or more components comprising the product, wherein the inquiry solicits granular information on at least a portion of the one or more components.

3. The computer-implemented method of claim 2, wherein the product review comprises the granular information.

4. The computer-implemented method of claim 1, further comprising:
obtaining, by the one or more processors, unstructured feedback relevant to the product;
analyzing, by the one or more processors, the unstructured feedback via a natural language processing algorithm to isolate granular feedback pertaining to components comprising the product; and
updating, by the one or more processors, the product review based on the granular feedback.

5. The computer-implemented method of claim 4, wherein obtaining the unstructured feedback comprises:
controlling, by the one or more processors, at least one Internet of Things device to monitor an area proximate to the product, wherein the unstructured feedback comprises audio data collected by the at least one Internet of Things device.

6. The computer-implemented method of claim 4, wherein obtaining the unstructured feedback comprises:
identifying, by the one or more processors, on one or more public product review sites, text relevant to the product, wherein the unstructured feedback comprises the text.

7. The computer-implemented method of claim 1, wherein each event of the one or more trigger events is selected from the group consisting of: taking delivery of the product, purchasing a similar product, requesting a repair for the product, and utilizing the product in a manner outside an established pattern of use.

8. The computer-implemented method of claim 1, wherein determining that a trigger event of the one or more trigger events has occurred comprises:
controlling, by the one or more processors, at least one Internet of Things device to monitor an area proximate to the product;
based on the monitoring, generating, by the one or more processors, a baseline model representing a usage pattern of the product by the user; and
identifying, by the one or more processors, at least one outlier to the baseline model.

9. The computer-implemented method of claim 1, wherein determining that a trigger event of the one or more trigger events has occurred comprises:
controlling, by the one or more processors, at least one Internet of Things device to monitor an area proximate to the product; and
based on the monitoring, determining, by the one or more processors, that the user has not utilized the product within a pre-configured time window for usage of the product.

10. The computer-implemented method of claim 1, wherein generating the product review based on the feedback obtained responsive to the inquiry further comprises:
determining, by the one or more processors, if there is an existing product review for the product;
based on determining that there is an existing product review for the product, updating, by the one or more processors, the existing review to generate the product review; and
based on determining that there is no existing review, generating the product review based on the feedback obtained responsive to the inquiry.

11. The computer-implemented method of claim 1, further comprising:
determining, by the one or more processors, that a trigger event for delivery of the product review of the product has occurred; and
transmitting, by the one or more processors, the product review to the user.

12. The computer-implemented method of claim 11, further comprising:
obtaining, by the one or more processors, from one or more Internet of Things devices proximate to the user, demographic information related to the user;
filtering, by the one or more processors, the product review based on the demographic information; and
transmitting, by the one or more processors, the filtered review to the user.

13. A computer system for facilitating granular real-time data attainment and delivery comprising:
a memory; and
one or more processors in communication with the memory, wherein the computer system is configured to perform a method, said method comprising:
determining, by the one or more processors, that a user has purchased a product;
classifying, by the one or more processors, with at least one trained algorithm, the product into a product type classification;
implementing, by the one or more processors, one or more trigger events, wherein based on each trigger event occurring, the one or more processors automatically generate and transmit an inquiry to the user, wherein at least one of the one or more trigger events is implemented based on the product type classification;
determining, by the one or more processors, that a trigger event of the one or more trigger events has occurred;
based on the determining, generating, by the one or more processors, the inquiry to the user to solicit feedback on the product;
obtaining, by the one or more processors, the feedback responsive to the inquiry; and
generating, by the one or more processors, a product review based on the feedback obtained responsive to the inquiry.

14. The computer system of claim 13, the method further comprising:
identifying, by the one or more processors, based on the product type classification, one or more components comprising the product, wherein the inquiry solicits granular information on at least a portion of the one or more components.

15. The computer system of claim 14, wherein the product review comprises the granular information.

16. The computer system of claim 13, the method further comprising:
obtaining, by the one or more processors, unstructured feedback relevant to the product;
analyzing, by the one or more processors, the unstructured feedback via a natural language processing algorithm to isolate granular feedback pertaining to components comprising the product; and
updating, by the one or more processors, the product review based on the granular feedback.

17. The computer system of claim 16, wherein obtaining the unstructured feedback comprises:
controlling, by the one or more processors, at least one Internet of Things device to monitor an area proximate to the product, wherein the unstructured feedback comprises audio data collected by the at least one Internet of Things device.

18. The computer system of claim 16, wherein obtaining the unstructured feedback comprises:
identifying, by the one or more processors, on one or more public product review sites, text relevant to the product, wherein the unstructured feedback comprises the text.

19. The computer system of claim 13, wherein each event of the one or more trigger events is selected from the group consisting of: taking delivery of the product, purchasing a similar product, requesting a repair for the product, and utilizing the product in a manner outside an established pattern of use.

20. A computer program product for facilitating granular real-time data attainment and delivery, the computer program product comprising:
one or more computer readable storage media and program instructions collectively stored on the one or more computer readable storage media readable by at least one processing circuit to perform a method comprising:
determining, by the one or more processors, that a user has purchased a product;
classifying, by the one or more processors, with at least one trained algorithm, the product into a product type classification;
implementing, by the one or more processors, one or more trigger events, wherein based on each trigger event occurring, the one or more processors automatically generate and transmit an inquiry to the user, wherein at least one of the one or more trigger events is implemented based on the product type classification;
determining, by the one or more processors, that a trigger event of the one or more trigger events has occurred;
based on the determining, generating, by the one or more processors, the inquiry to the user to solicit feedback on the product;
obtaining, by the one or more processors, the feedback responsive to the inquiry; and
generating, by the one or more processors, a product review based on the feedback obtained responsive to the inquiry.
